(19) United States
(12) Patent Application Publication
(10) Pub. No.: US 2018/0287237 A1
(43) Pub. Date: Oct. 4, 2018

(54) Metal-Air Battery

(71) Applicant: Board of Regents, The University of Texas System, Austin, TX (US)

(72) Inventors: Arumugam Manthiram, Austin, TX (US); Longjun Li, Union City, CA (US)

(21) Appl. No.: 16/002,609

(22) Filed: Jun. 7, 2018

Related U.S. Application Data
(63) Continuation of application No. PCT/US2016/060253, filed on Nov. 3, 2016.
(60) Provisional application No. 62/265,831, filed on Dec. 10, 2015.

(51) Int. Cl. H01M 12/08; H01M 4/92; H01M 4/90

(52) U.S. Cl. CPC H01M 12/08; H01M 4/923; H01M 4/926; H01M 2300/0008; H01M 4/9008; H01M 2300/0014; H01M 2300/0071; H01M 4/921

(57) ABSTRACT

The present disclosure relates to a metal-air battery, such as a zinc (Zn)-air battery with a decoupled cathode, an acidic catholyte, an alkaline anode electrolyte, and a solid electrolyte between the catholyte and the anode electrolyte.

### CROSS-REFERENCE TO RELATED APPLICATIONS

The present application is a continuation of International Application No. PCT/US2016/060253 Filed Nov. 3, 2016; which claims priority to U.S. Provisional Application Ser. 62/265,831, filed Dec. 10, 2015, the contents of which are incorporated by reference herein in their entirety.

### STATEMENT OF GOVERNMENT INTEREST

This invention was made with government support under Grant no. DE-SC0005397 awarded by the Department of Energy. The government has certain rights in the invention.

### TECHNICAL FIELD

The present invention relates to a metal-air battery, such as a zinc (Zn)-air, lithium (Li)-air, sodium (Na)-air, potassium (K)-air, magnesium (Mg)-air, calcium (Ca)-air, iron (Fe)-air, aluminum (Al)-air, silicon (Si)-air, germanium (Ge)-air or tin (Sn)-air batteries and methods of making and using such a battery.

### BACKGROUND

Metal air batteries are rechargeable batteries with a metal anode and a cathode that reversibly reacts with oxygen in the air. A number of metal air batteries, including lithium (Li)-air batteries and zinc (Zn)-air batteries are being developed. However, various problems have hampered their commercial acceptance. For instance, Zn-air batteries, when used with common electrolytes, operate only at a low voltage of around 1 V. In addition, over a number of charge/discharge cycles, Zn tends to form dendrites (small tentacles of Zn metal) from the anode to the cathode, which short circuits the battery. Furthermore, carbonates tend to form when components of the alkaline anode electrolyte react with carbon dioxide in the air. These carbonate clog up the cathode, preventing efficient reaction and eventually decreasing the number of charge/discharge cycles for which the battery may be used. An acidic electrolyte cannot be used in a basic battery format because it reacts violently with Zn in the anode. Finally, Zn tends to be lost from the anode over time because zincate (Zn(OH)₄²⁻) formed when the battery is discharged migrates away from the anode in the electrolyte.

Air batteries using other metals suffer from similar problems. These problems have not been solved, despite the immense interest in low-cost, high-energy-density batteries in recent years.

### SUMMARY

The disclosure relates to a zinc (Zn)-air battery including a Zn metal anode, an alkaline anode electrolyte disposed adjacent the Zn metal anode, a decoupled air cathode including an oxygen reduction reaction (ORR) component and an oxygen evolution reaction (OER) component, wherein the ORR component and OER component are physically separate, an acidic catholyte disposed adjacent the decoupled air cathode, and a solid electrolyte disposed between the alkaline anode electrolyte and the acidic catholyte.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Embodiments of the present invention may be better understood through reference to the following figures in which:

FIG. 1A is a cross-sectional schematic drawing of a zinc-air battery during discharge;

FIG. 1B is a cross-sectional schematic drawing of a zinc-air battery during charge;

FIG. 2A is a low-magnification scanning electron microscope (SEM) image of Ti gauze with IrO₂ coating;

FIG. 2B is an SEM image of a single wire in Ti gauze with IrO₂ coating;

FIG. 2C is a further-magnified SEM image of IrO₂ on Ti gauze;

FIG. 2D is a high-resolution SEM image of IrO₂ on TI gauze;

FIG. 2E is an X-ray photon spectroscopy (XPS) signal analysis for iridium (Ir) in IrO₂ on TI gauze;

FIG. 2F is an X-ray photon spectroscopy (XPS) signal analysis for oxygen (O) in IrO₂ on TI gauze;

FIG. 3A is a linear sweep voltammetry (LSVs) of IrO₂@Ti in phosphate buffer as tested with a three-electrode half cell;

FIG. 3B is a Tafel plot based on FIG. 3A;

FIG. 3C is a chronopotentiometry plot for IrO₂@Ti at a current density of 0.5 mA/cm²;

FIG. 4A is a charge and discharge voltage profile at 0.5 mA/cm² of a Zn-air battery containing LiNO₃ in the anode electrolyte (0.5 M LiOH+1 M LiNO₃);

FIG. 4B is an X-ray diffraction (XRD) pattern of a Zn metal plate after immersion in 0.5 M LiOH+1 M LiNO₃ for two days;

FIG. 4C is an SEM image of a Zn metal plate after immersion in 0.5 M LiOH+1 M LiNO₃ for two days;

FIG. 4D is an SEM image of a Zn metal without immersion in any electrolyte;

FIG. 5A is an SEM image of a Zn metal plate after immersion in 0.5 M LiOH alone for two days;

FIG. 5B is an XRd pattern of a Zn metal plate after immersion in 0.5 M LiOH alone for two days;

FIG. 5C is a linear scanning voltammetry and power density plot for a Zn-air battery without acid in the anode electrolyte (0.5 M LiOH alone);

FIG. 5D is a charge and discharge voltage profile of a Zn-air battery without LiNO₃ in the anode electrolyte (0.5 M LiOH alone);

FIG. 6A is a cycling voltage profile for 50 cycles of a Zn-air battery with a 0.5 M LiOH anode electrolyte and Pt/C+IrO₂@Ti decoupled air cathode; and

FIG. 6B is an enlarged cycling voltage profile of FIG. 6A for the first and fiftieth cycles.

### DETAILED DESCRIPTION

The present invention relates to a metal-air battery with a metal anode, an anode electrolyte, a solid electrolyte, an acidic catholyte, and a decoupled air cathode. Such a battery may be charged and discharged for more than one cycle. Metal-air batteries described herein may be useful in a variety of applications, such as consumer electronics, renewable energy storage, or electric transportation. Although the examples described herein relate to zinc-air batteries, other metals, such as, lithium (Li), sodium (Na), potassium (K), magnesium (Mg), calcium (Ca), iron (Fe), aluminum (Al), silicon (Si), germanium (Ge) and tin (Sn) may also be used in place of Zn. The anode electrolyte, correspondingly, should be alkaline or neutral aqueous solutions or nonaqueous solutions, depending on the compatibility with the anode metals.

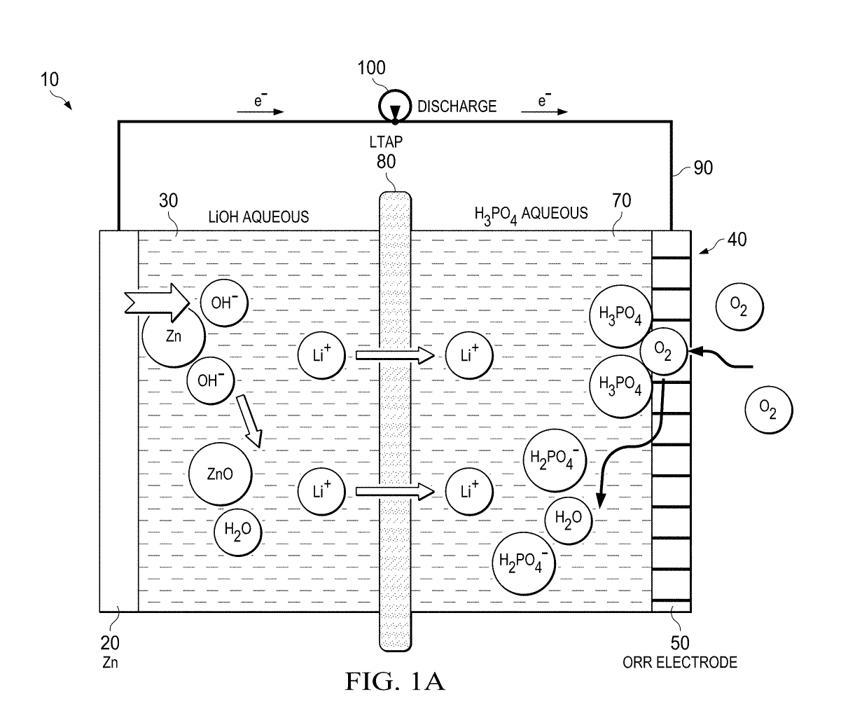

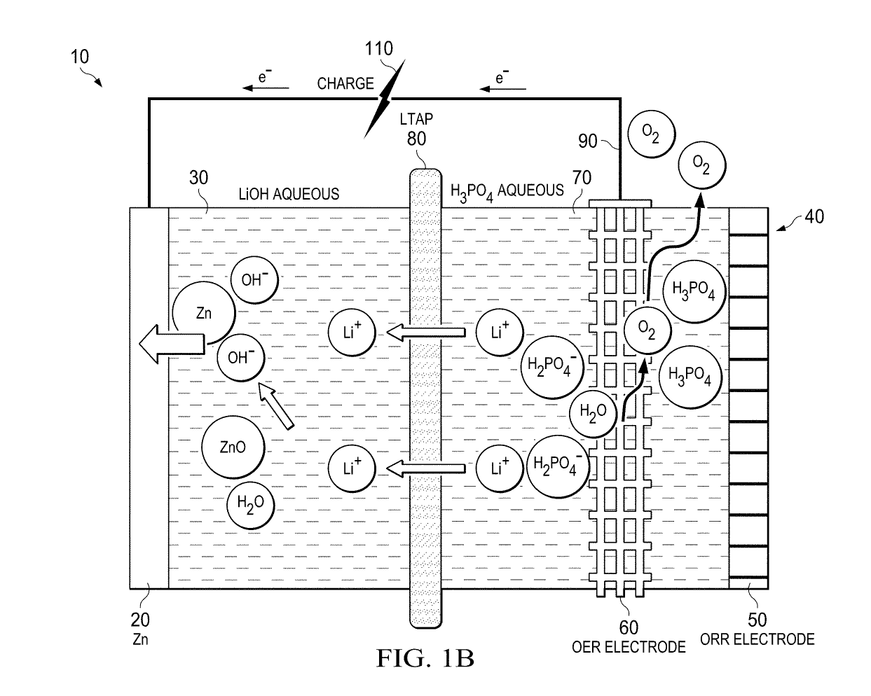

Referring to FIG. 1A and FIG. 1B, Zn-air battery 10 includes a Zn metal anode 20, an alkaline anode electrolyte 30 disposed adjacent to Zn metal anode 20, a decoupled air cathode 40, containing oxygen reduction reaction (ORR) component 50 and oxygen evolution reaction (OER) component 60, an acidic catholyte 70 disposed adjacent to decoupled air cathode 40, and a solid electrolyte 80 disposed between alkaline anode electrolyte 30 and acidic catholyte 80. During charge and discharge, Zn-air battery 10 is coupled to an external circuit 90. During discharge, external circuit 90 may include a device 100, that is powered by Zn-air battery 10. During charge, external circuit 90 may include a power source 110, that provides energy to Zn-air battery 10.

Anode 20 may include Zn metal, as shown in FIG. 1A and FIG. 1B or any Zn alloy that is able to react with anode electrolyte 10 to form zincate or Zn metal, depending on whether electrons are being supplied to or removed from anode 20. Anode 20 may be in any form, but will often be a metal sheet, metal foil, or binded metal powder. Anode 20 may include a backing or other components to provide structural support or electrical connectivity to external circuit 90.

Anode electrolyte 30 is an alkaline electrolyte. It may have a pH of at least 7.1, at least 7.5, at least 8, at least 9, or at least 10. The pH of anode electrolyte 30 may be based in part upon the metal used in anode 20 and the composition of solid electrolyte 80 so that solid electrolyte 80 is not destroyed and an acid reaction with anode 20 does not take place at any point during the charge or discharge cycle. Anode electrolyte 30 may contain a hydronium (OH⁻) ion to allow zincate to form. However, if anode electrolyte 30 contains a different ion, then a different Zn-compound may form. In the example of FIG. 1A and FIG. 1B, anode electrolyte 30 may include aqueous lithium hydroxide (LiOH). In this case, the lithium ions (Li⁺) combine with the OFF ions to form LiOH when the OFF ions are released from zincate. Li⁺ dissociate from the OFF ions when Zn⁺ is present due to loss of electrons from anode 20 during discharge. Other suitable anode electrolytes include NaOH and KOH, depending on the cations in the solid electrolytes. Anode electrolyte 30 may include a mixture of different compositions and may change in composition during battery cycling.

Decoupled air cathode 40 includes an ORR component 50 and an OER component 60. Only ORR component 50 is shown in FIG. 1A for simplicity. ORR component 50 reduces oxygen (O₂) in the air to allow it to react with catholyte 70. ORR contains an ORR catalyst to facilitate this reaction. The OER component 60 releases oxygen from catholyte 70 into the air. the OER contains an OER catalyst, which is typically different than the ORR catalyst, to facilitate this reaction. Decoupled air cathode 40 contains a separate ORR component 50 and OER component 60 because the active sites for the ORR and the OER and the electrochemical environment in which the reactions occur are so different that it is very difficult to achieve high activity for both reactions within one material. For example, the ORR typically uses hydrophobic sites, which form a three-phase (solid catalyst, liquid electrolyte, and air) interface. In contrast, the OER typically uses hydrophilic sites to maximize the contact between the catalyst and the electrolyte. By dividing the ORR and OER functions into two different physical components 50 and 60 of the decoupled air cathode 40, which may be two different electrodes, the two different physical components 50 and 60 may be optimized for ORR and OER respectively. This allows high battery efficiency as well as long cycle life. Such as design has been used previously with alkaline metal-air batteries, but no such design has been used for acidic metal-air batteries.

ORR component 50 may include any ORR catalyst able to reduce oxygen in the air so that it may react with catholyte 60. The exact identity of the ORR catalyst as well as the location of ORR component 50 may depend somewhat on what constitutes cathlolyte 70. Example ORR catalysts include a noble-metal-based catalyst, such as platinum (Pt), palladium (Pd), silver (Ag), and their alloys or non-noble-metal-based catalysts such as cobalt-polypyrrole (Co-PPY-C), iron/nitrogen/carbon(Fe/N/C), or pure carbon with hetero-atom dopants, such as nitrogen (N)-doped graphene, carbon nanotube, or mesoporous carbon. Because it is decoupled from the OER component 50, the ORR electrode component may be isolated during the high-voltage charge process, minimizing catalyst dissolution and oxidation.

OER component 60 may include any OER catalyst able to evolve oxygen from catholyte 70 into the air. The exact identity of the OER catalyst as well as the location of OER component 60 may depend somewhat on what constitutes cathlolyte 70. For instance, the OER catalyst may have a set stability, activity, or both in a solution with the catholyte's acidity. Any support, particularly conductive supports, may have less than a set chemical reactivity with catholyte 70 and may have a set stability at the catholyte's acidity. Any support may also have low or no OER activity, particularly as compared to the OER catalyst. Example OER catalysts include iridium oxide (IrO₂), which may be in the form or a thin film grown on a titanium (Ti) mesh (IrO₂@Ti). Other materials like MnOₓ, PbO₂, and their derivatives are also suitable OER catalysts. Other OER catalysts may be free-standing, or on different conductive supports, such as other metal meshes. The OER catalyst may be present in small particles, such as particles less than 100 nm, less than 50 nm, or less than 20 nm in average diameter. In order to present a high number of active sites to the catholyte, the OER catalyst may be amorphous. OER component 60 may be carbon-free and binder-free, ensuring good mechanical integrity in the high-voltage oxidizing environment encountered in battery 10.

In order to allow access to air, decoupled air cathode 40, or at least ORR component 50 may be porous. OER component may also be porous. Any porous component may be sufficient to retain catholyte 70, or other components of battery 10 may instead allow air to reach decoupled air cathode 40, or at least ORR component 50, while containing catholyte 70.

Catholyte 70 may include composition able to be catalyzed by both ORR component 50 and OER component 60. In the example of FIG. 1A and FIG. 1B, catholyte 70 includes aqueous phosphoric acid (H₃PO₄). Other acids, including inorganic and organic acids, such as HCl, H₂SO₄, HNO₃, HClO₄, CH₃COOH, and C₃H₄O₄, may also be used. Catholyte 70 may include mixtures of different compositions, such as H₃PO₄ lithium dihydrogen phosphate (LiH₂PO₄). The composition of catholyte 70 may change during battery cycling. Because catholyte 70 is acidic, it prevents CO₂ ingression from the air, which is a problem associated with alkaline electrolytes.

Solid electrolyte 80 is located between anode electrolyte 30 and catholyte 70 so as to prevent their direct chemical reaction with one another during normal cell operation and so as to prevent the acidification on anode electrolyte 30 or contact between anode 20 and any acidic component during normal battery operation. Solid electrolyte 80 also prevents any dendrites formed on anode 20 from reaching cathode 40 during normal battery operation. Furthermore, solid electrolyte 80 may be able to exchange ions or charge with anode electrolyte 20 and catholyte 70. Solid electrolyte 80 may provide ionic channels. In addition, solid electrolyte 80 may confine zincate to anode electrolyte 30, thereby reducing or preventing Zn loss over multiple charge/discharge cycles.

Any H⁺ diffusing through solid electrolyte 80 will neutralize the anode electrolyte or even corrode the Zn metal at anode 30. Solid electrolyte 80 may therefore, also prevent H⁺ diffusion.

In general, more ionically conductive (except for H⁺) solid electrolytes 80 and thinner solid electrolytes 80 may improve various performance characteristics of battery 10.

In FIGS. 1A and 1B, the solid electrolyte is a NASICON-type Li-ion solid electrolyte (LTAP). The solid electrolyte may also include other Li-ion, Na-ion and K-ion solid electrolytes, or combinations of solid electrolytes such as garnet Li₇₋ₓ La₃Zr₂₋ₓTaₓO₁₂, perovskite Li₃ₓLa_{(2/3)-x}□_{(1/3)-2x}TiO₃, LISICON Li₁₄ZnGe₄O₁₆, silicon wafer, beta-Alumina, Na_{0.75}Fe_{0.75}Ti_{0.25}O₂, K_{0.72}In_{0.72} Sn_{0.28}O₂, K₄Nb₆O₁₇, and solid polymer electrolytes. When solid electrolyte 80 is LTAP, H⁺ diffusion is avoided because H⁺ are absorbed on the LTAP surfaace and do not pass through the material. This occurs because H⁺ form a strong bond with nearby oxygen upon absorption onto LTAP, which leads to a large energy barrier for H⁺ diffusion. The energy barrier of Li⁺ (0.79 eV) is much lower than that of H⁺ (3.21 eV), allowing Li⁺ to pass through, while H⁺ are detained.

As FIG. 1A and FIG. 1B makes clear, the ions gained or lost from anode 30 and cathode 40 and ions in the various electrolytes need not all be the same ion. For instance, a Zn-metal anode 20 may be electrochemically active with Li-ion exchange at the membrane. One or more of the electrolytes may, however, be compatible with the exchange of ions across the battery.

Zn-air battery 10 may be able to provide a discharge voltage of at least 1.5 V, at least 1.7 V, or least 1.9 V. The voltage of Zn-air battery may be increased by increasing the acidity of catholyte 70, thereby increasing the potential of cathode 40, by increasing the alkalinity of the anode electrolyte 30, thereby decreasing the anode potential, or both. However, the pH of catholyte 70 and anode electrolyte 30 may be limited and may be controlled within a range to avoid any significant corrosion of solid electrolyte 80.

Zn-air battery 10 may exhibit a voltaic efficiency of at least 70%, at least 75%, or at least 80% at 0.1 mA/cm². Zn-air battery 10 may retain at least 90% or at least 95% of its initial discharge voltage or voltaic efficiency after cycling for at least 50 hours, at least 100 hours, or at least 200 hours in ambient air, or after cycling for at least 50 cycles or at least 100 cycles in ambient air.

Zn-air battery 10 may be operated at any suitable current range, depending on the resistance of the solid electrolyte.

Zn-air battery 10 may be largely an electrochemical cell, such as a standard format battery, for example a coin cell. Such standard format batteries may contain other standard components, such as a case and contacts. Zn-air battery 10 may also be used in a multi-cell battery, which contains at least two Zn-air batteries 10. The Zn-air batteries 10 in a multi-cell battery may be organized in parallel or in series and the multi-cell battery may contain other components, such as a housing.

Zn-air batteries 10 may also contain safety, monitoring, or regulator components, such as voltage meters, other electrical meters, thermometers, fire suppression materials, alarms, and even circuit boards or computers.

### EXAMPLES

The present invention may be better understood through reference to the following examples. These examples are included to describe exemplary embodiments only and should not be interpreted to encompass the entire breadth of the invention.

### Chemicals and Materials

The following chemicals and materials available from typical commercial sources were used in these Examples: potassium hexachloroiridate (K₂IrCl₆), iridium oxide (IrO₂), oxalic acid (H₂C₂O₄.2H₂O), potassium carbonate (K₂CO₃), titanium gauze (Ti, 80 mesh), titanium wire (0.031 inch diameter), phosphoric acid (H₃PO₄), lithium dihydrogen phosphate (LiH₂PO₄), Zn plate, potassium hydroxide (KOH, 85.3%), lithium hydroxide monohydrate (LiOH.H₂O), lithium nitrate (LiNO₃, 99%), Pt/C (20 wt. %), and acelyene black (AB).

Iridium oxide films on Ti Gauze (IrO₂@Ti) used in these Examples were synthesized by an anodic electrodeposition method. K₃IrCl₆ (0.2 mmol) and H₂C₂O₄.2H₂O (1 mmol) were dissolved in water (30 mL) in a beaker and stirred for about five minutes. Then K₂CO₃ (5 mmol) was added into the mixture to adjust the pH value to ˜10. Afterwards, more water (20 mL) was added into the solution and stirred at 35° C. for 9 days until a dark blue solution (IrO₂ colloid) was formed. The IrO₂ colloidal solution was poured into a three-electrode glass cell in an ice bath. A rectangular-shaped Ti gauze with a width of 1 cm was inserted into the solution about 1 cm deep (depositing area 1 cm²). Reference and working electrodes for the electrodeposition were, respectively, a saturated calomel electrode (SCE) and a platinum (Pt) wire. A fixed anodic current of 35 μA was applied to the working electrode, leading to a current density of 35 μA/cm². The deposition time was 5000 s, resulting in a deposition of 0.27 mg/cm². This resulted in a IrO₂@Ti electrode.

### Morhphological Characterization

The morphology of the IrO₂@Ti, the Ti gauze used to create it, and Zn plates used in these Examples were studied with a Hitachi S-5500 scanning transmission electron microscope (STEM). IrO₂ colloid particles were observed with a JEOL 2010F transmission electron microcope (TEM) at 200 keV. X-ray diffration (XRD) data was collected with a Philips X-ray diffractometer equipped with CuKα radiation at a scan rate of 0.03 Vs. X-ray photoelectron spectroscopy (XPS) data were collected with a Kratos Analytical spectrometer.

### Electrochemical Characterization

In these Examples, the intrinsic catalytic activity and stability of IrO₂@Ti and Ti gauze were studied by linear sweep voltammetry (LSV) and chronopotentiometry in a three-electrode half-cell with a SCE reference electrode, a Pt flag counter electrode, and a phosphate buffer electrolyte (0.1 M H₃PO₄+1 M LiH₂PO₄). The LSVs were collected from 0.1 to 1.8 V vs. SCE at a scan rate of 1 mV s⁻¹ with an Autolab PGSTAT302N potentiostat (Eco Chemie B.V., Netherlands). The chronopotentiometry plot was obtained with a current density of 0.5 mA cm⁻² on an Arbin BT 2000 battery cycler (Arbin Instruments, TX, US).

### Example 1: Zn Air Battery Assemblies and Characterization Methods

Acidic Zn-air batteries used in the present Examples were assembled in a layered battery format. The anode was a Zn plate connected to a Ti wire current collector. The anode electrolyte contained 2 mL of 0.5 M LiOH or 0.5 M LiOH+1 M LiNO₃. The solid electrolyte was a LTAP (Li_{1+x+y}Ti₂₋ₓ AlₓP_{3-y}Si_{y}O₁₂) membrane that was 0.15 mm thick, 0.76 cm×0.76 cm; =1×10⁻⁴ S/cm. The catholyte was 2 mL of 0.1 M H₃PO₄+1 M LiH₂PO₄. The OER electrode was IrO₂@Ti with the electrode area cut to 0.76 cm×0.76 cm to fit into the battery. The ORR electrode was Pt/C (20 wt %, 1 mg/cm²) nanopowder sprayed onto a gas diffusion layer with 20 wt % LithION™ binder (Ion Power, USA). For the bifunctional Pt/C+IrO₂ air electrodes, Pt/C and IrO₂ nanopowder were sprayed on the gas diffusion layer with the loadings of 1 mg/cm²+1 mg/cm².

Polarization curves were recorded with a scan rate of 10 mV/s. Discharge-charge experiments were conducted with an Arbin BT 2000 battery cycler with a 5-minute rest time between each discharge and charge period, which was set to be 2 h. For the battery with a decoupled cathode, two independent Arbin channels were used to collect the discharge and charge data alternatively with a 5-minute rest time between each discharge and charge period.

### Example 2: Zn Air Battery Charge/Discharge Mechanism

Zn-Air batteries according to these Examples during discharge and charge are shown in FIG. 1A and FIG. 1B, respectively.

As shown in FIG. 1A, during discharge, oxygen (O₂) from air diffuses into the porous ORR component 50 of decoupled air cathode 40, gets reduced, and combines with phosphoric acid (H₃PO₄) in catholyte 70 to form phosphate dihydrogen ions (H₂PO₄⁻) and H₂O. At anode 20, Zn is oxidized and combines with hydroxide ions (OH⁻) in anode electrolyte 30 to form zincate (Zn(OH)₄²⁻). Zincate tends to decay into zinc oxide (ZnO) and water (H₂O) after reaching its solubility limit. To balance the charge in anode electrolyte 30 and catholyte 70, lithium ions (Li⁺) in anode electrolyte 30 diffuse from the anode side to the cathode side through solid electrolyte 80, which defines the two sides of battery 10.

As shown in FIG. 1B, during charge, at OER component 60 of decoupled air cathode 40, H₂O is split into O₂ and H⁺. H⁺ combines with H₂PO₄⁻ to form H₃PO₄. Li⁺ in catholyte 70 diffuse back through solid electrolyte 80 into anode electrolyte 30. At anode 30, Zn(OH)₄²⁻ is reduced into Zn and OFF. While Zn is plated on Zn anode 30, OH⁻ combines with Li⁺ to form LiOH.

### Example 3: IrO₂@Ti Cathode Characterization

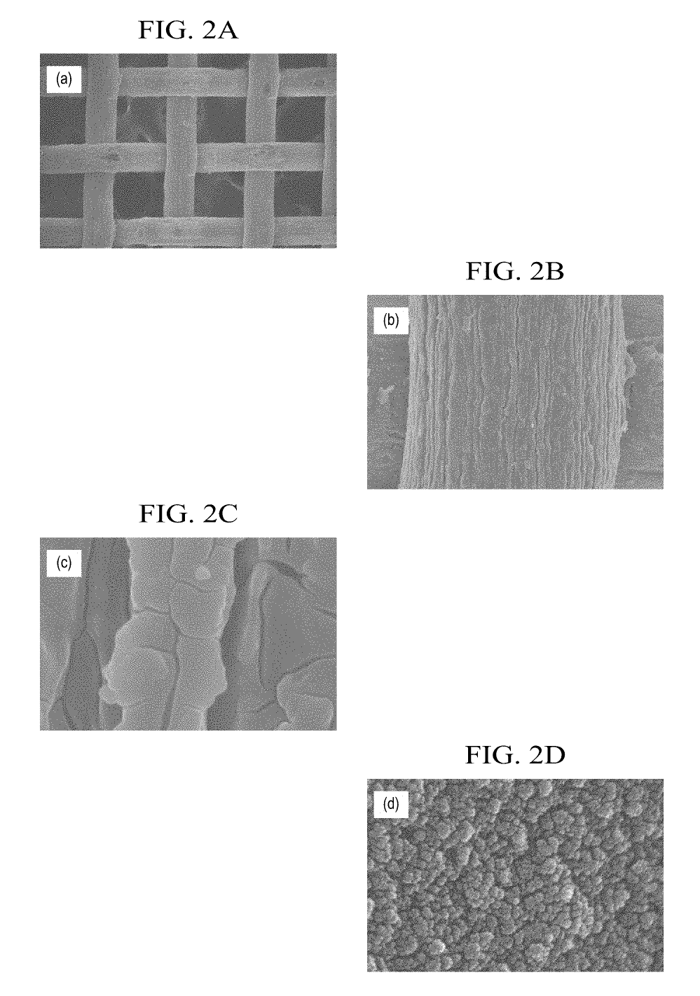

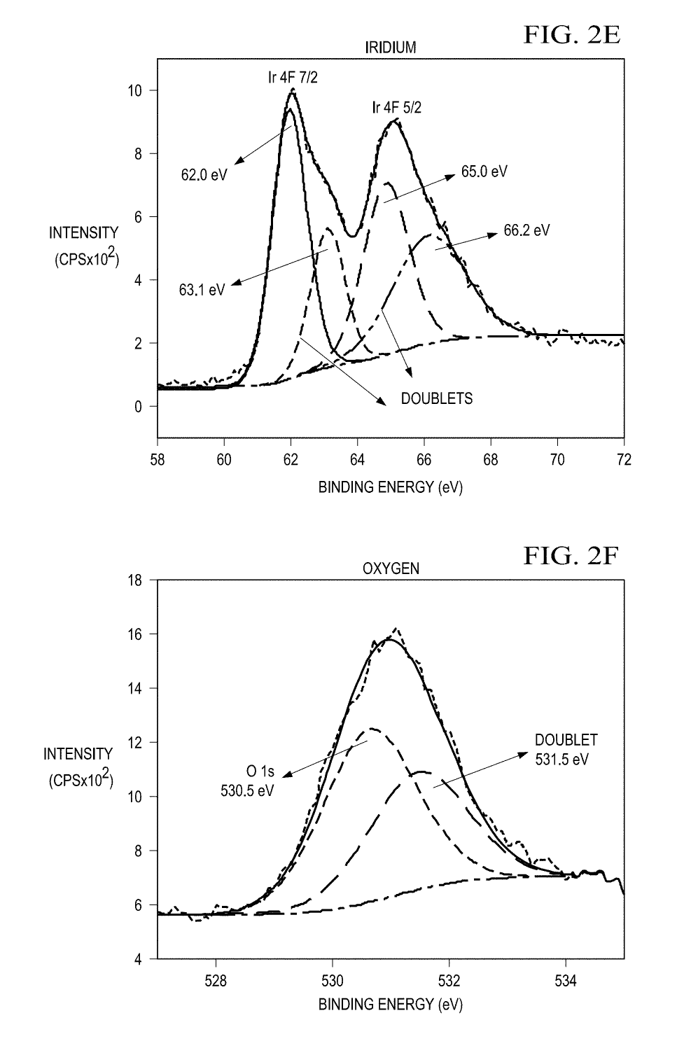

The IrO₂@Ti OER electrode used in these Examples had an overall morphology shown in FIGS. 2B-2D. FIG. 2A is the overall morphology of Ti gauze with IrO₂ coating. The wire diameter is ˜130 μm. IrO₂ formed a thin layer on the mesh wires, like a tree skin, which is shown in FIG. 2B. Zooming in, in FIG. 2C, the IrO₂ coating was found to be full of micro cracks, which enhanced the infiltration of catholyte into the catalyst layer. The high-resolution SEM image of FIG. 2D shows that the IrO₂ coating is actually made of numerous IrO₂ nanoparticles with a size of <20 nm. This particle size was confirmed by TEM. In addition, the particles were amorphous; they showed no peaks in XRD.

X-ray photoelectron spectroscopy (XPS) analysis was conducted to study the oxidation states of IrO₂ films on Ti gauze. In FIG. 2E, the iridium signal exhibits two different peaks with binding energies of 62.0 and 65.0 eV, which could be assigned to, respectively, Ir⁴⁺4f_{7/2} and 4f_{5/2}. There were also two doublets located at 63.1 and 66.2 eV, which are believed to be caused by the existence of higher-oxidation-state iridium. This conclusion was further supported by the analysis of the O1s peak shown in FIG. 2F. The additional doublet peak is around 531.5 eV, which is ˜1 eV higher than the main peak located at 530.5 eV. The quantitative analysis of the XPS peaks, which showed the atomic ratio of Ir and O to be 21:79, further supports the conclusion that there was excess oxygen with a higher-oxidation-state iridium.

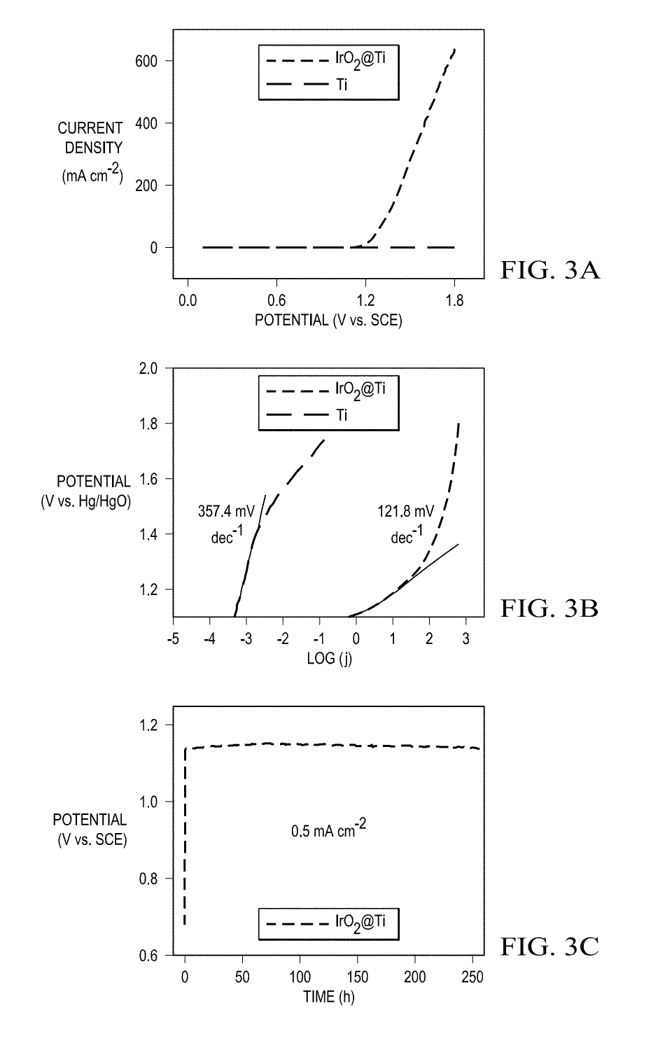

The electrochemical performance of the IrO₂@Ti in phosphate buffer was tested with a three-electrode half cell. The counter and reference electrodes were, respectively, a Pt flag and saturated calomel electrode (SCE). In the linear sweep voltammetry (LSVs) shown in FIG. 3A, the Ti gauze shows nearly zero current density within a wide potential range of 0.1-1.8 V vs. SCE. This indicates the negligible OER activity of Ti in the phosphate buffer electrolyte as well as its good stability. After a thin layer of IrO₂ (0.27 mg/cm²) was deposited onto the Ti gauze, the anodic current increased sharply beyond the onset potential around 1.2 V vs. SCE. The current density at 1.8 V vs. SCE is 4000× higher than that of Ti gauze, proving the ultra-high activity of IrO₂@Ti in the phosphate buffer electrolyte.

A prolonged deposition time (20,000 s) was tried, leading to an increased IrO₂ loading of ˜1 mg/cm². However, the electrode did not perform well becasue the IrO₂ layer started to peel off the Ti substrate due to internal tension.

To further study the OER reaction mechanism, Tafel plots based on the LSVs were calculated and plotted (FIG. 3B). The Tafel slope of Ti is large around 357.4 mV/dec, which indicates the poor intrinsic OER activity of Ti metal in acidic solution. However, for IrO₂@Ti, the Tafel slope at a low current range is as low as 121.8 mV/dec. The Tafel slope increases sharply in the high-current range (>100 mA/cm²), which may be due to the accumulation of oxygen bubbles on the electrode, blocking the contact between the catalyst and the electrolyte. The stability of IrO₂@Ti was tested by chronopotentiometry at a current density of 0.5 mA/cm² as shown in FIG. 3C. The charge potential quickly rises to ˜1.14 V vs. SCE upon charging. The charge potential is almost constant for more than 200 h without observable degradation. Thus IrO₂@Ti exhibits high intrinsic activity and durability.

### Example 4: Zn Anode Characterization

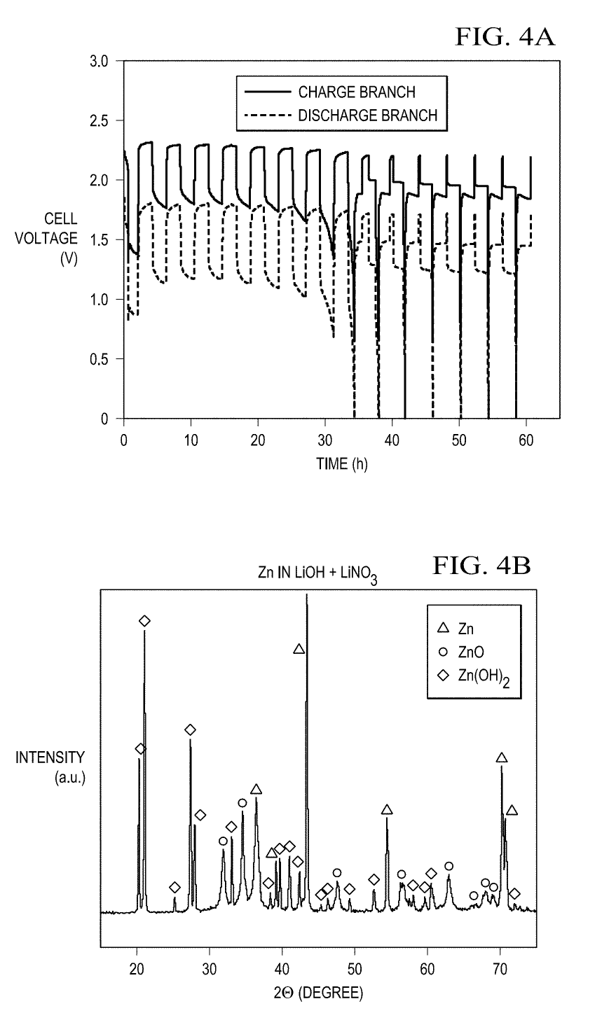

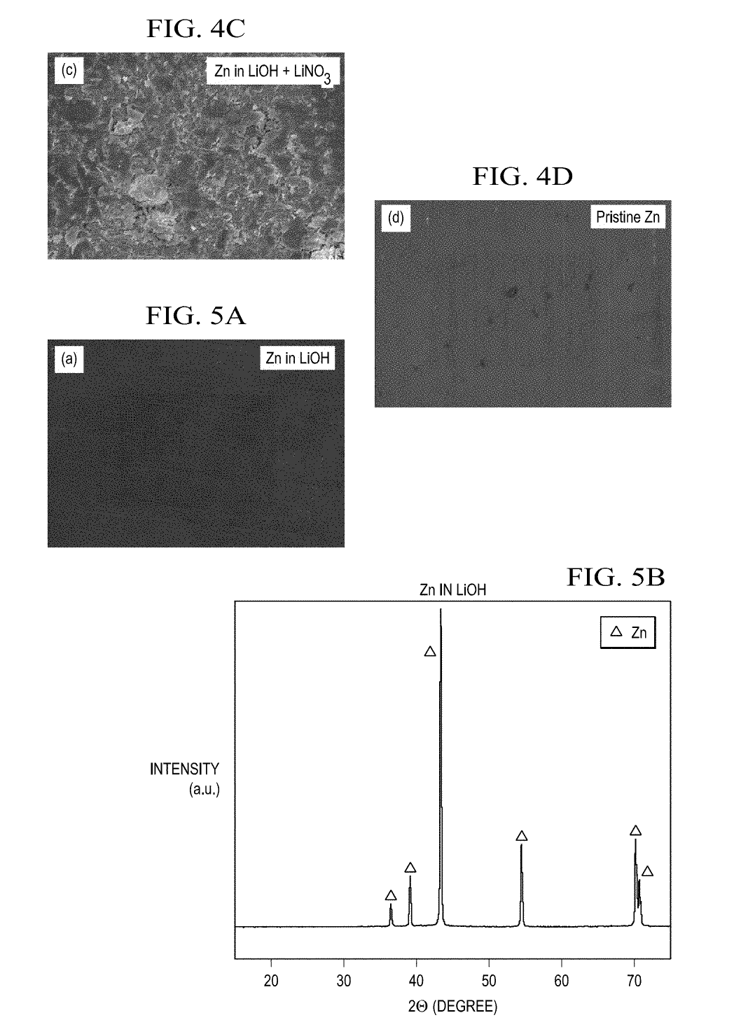

Zn-air batteries were assembled with a polished Zn plate anode, a 0.5 M LiOH+1 M LiNO₃ anode electrolyte, a NASICON-type Li-ion solid electrolyte (LTAP), a 0.1 M H₃PO₄+1 M LiH₂PO₄ catholyte, and a Pt/C+IrO₂@Ti decoupled air cathode. 0.5 M LiOH+1 M LiNO₃ was used as the anode electrolyte to create an alkaline environment for the Zn metal anode and provide good compatibility with the solid electrolyte. The discharge and charge voltage profiles at 0.5 mA/cm² are shown in FIG. 4A A current density of 0.5 mA/cm² was applied because it has been the most standard current density for batteries with the LTAP solid electrolyte. A higher current density could be applied upon improving the conductivity of the solid electrolyte. Although the open-circuit voltage of the battery was as high as 1.8 V, the initial discharge voltage was ˜0.9 V, which is even lower than the operating voltage of conventional Zn-air batteries (˜1 V). In addition, the battery could only be cycled for 8 cycles before it suffered from fast degradation. Given that similar a air electrode and solid electrolyte were previously demonstrated to be stable in Li-air batteries, the problem was attributed to the Zn anode.

To study the stability of Zn anode in the 0.5 M LiOH+1 M LiNO₃ electrolyte, a pristine Zn plate was immersed in a solution composed of 0.5 M LiOH+1 M LiNO₃. Upon immersion, the bright and shining Zn foil became dull and dark within several minutes, indicating a fast chemical reaction. After two days, the Zn foil was taken out from the solution, washed with ethanol and dried, and tested by X-ray diffraction (XRD), the results of which are shown in FIG. 4B. In FIG. 4B, most of the peaks correspond to Zn(OH)₂ and Zn, indicating chemical reaction between Zn metal and LiOH+LiNO₃ electrolyte. In addition, several minor peaks associated with ZnO were observed, which might be due to the dehydration of Zn(OH)₂ upon drying. The morphology features of Zn metal after immersion in LiOH+LiNO₃ were observed by scanning electron microscopy (SEM) as shown in FIG. 4C. As a comparison, the morphology of a pristine Zn metal surface is shown in FIG. 4D. Comparing these two images, a thick layer of crust has formed on the Zn metal surface after immersion in LiOH+LiNO₃, which is shown to be mostly Zn(OH)₂ from the XRD pattern in FIG. 4B. This thick layer may contribute substantially to fast degradation in the Zn-air battery. The insulating Zn(OH)₂ covers up the metal surface and prevents contact between the anode electrolyte and Zn anode, leading to a low initial discharge voltage and battery failure after around 30 h of operation. After analyzing the passivation layer on the Zn-metal anode, it appeared that the main problem arose from the LiNO₃ additive in the anode electrolyte, which is quite oxidative. The passivation layer on Zn-metal surface is both electronically and ionically insulating, cutting off the contact between Zn metal and the electrolyte and stopping battery reactions.

### Example 5: Zn Air Battery Characterization

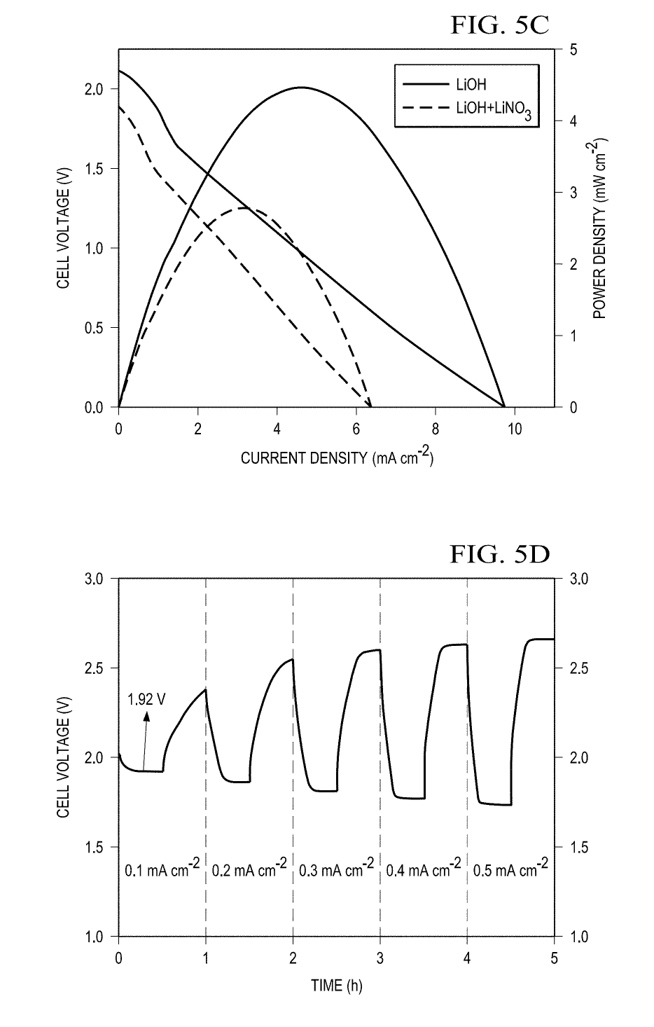

To eliminate the adverse effects of LiNO₃, only 0.5 M LiOH was used as the anode electrolyte. To study the compatibility of Zn metal with LiOH, a pristine Zn plate was immersed into 0.5 M LiOH. After two days, the Zn plate still maintained a shiny appearance, indicating good stability of Zn metal in 0.5 M LiOH. SEM and XRD characterizations of the Zn plate after removing it from 0.5 M LiOH, are shown in FIG. 5A and FIG. 5B, respectively. There was no observable passivation layer formed on the surface of Zn plate in FIG. 5A. The XRD pattern in FIG. 5B also shows pure Zn metal with no impurities.

A Zn-air battery was assembled with 0.5 M LiOH instead of 0.5 M LiOH+1 M LiNO₃ as the anode electrolyte. The linear scanning voltammetry and calculated power densities of the battery are shown in FIG. 5C. The Zn-air battery with LiOH anode electrolyte exhibited a higher open-circuit voltage (˜2.1 V) than the Zn-air battery with a LiOH+LiNO₃ anode electrolyte (˜1.8 V). The maximum power density of the Zn-air battery is also much higher when LiNO₃ is eliminated from the anode electrolyte. The discharge and charge profiles of Zn-air batteries at different current densities are shown in FIG. 5D. At a current density of 0.1 mA/cm², a high discharge voltage of ˜1.92 V was achieved, which is even 0.27 V higher than the theoretical cell voltage of conventional Zn-air batteries (1.65 V). The charge voltage at 0.1 mA/cm² was ˜2.37 V, leading to a high battery efficiency of ˜81.0%.

The working current density of the Zn-air batteries tested was smaller than conventional Zn-air batteries due to the much larger cell resistance associated with the thick solid electrolyte. Improvements in cell efficiency and rate capability are possible if a solid electrolyte with higher ionic conductivity and reduced thickness is used.

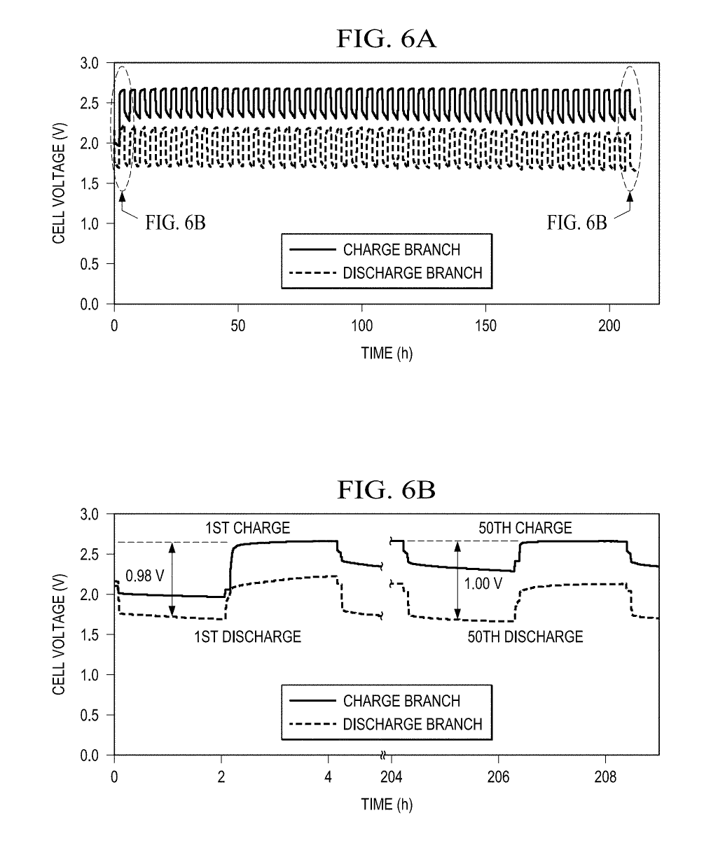

The cycling voltage profiles of Zn-air batteries with a 0.5 M LiOH anode electrolyte and Pt/C+IrO₂@Ti decoupled air cathode are shown in FIG. 6A and FIG. 6B. Because the cathode is decoupled, there are two sets of curves (red for discharge and black for charge) in the figure, representing the discharge and charge voltage profiles. In total, 50 cycles are present, with no observable degradation in performance, indicating the high stability of the Zn-air batteries. The initial round-trip overpotential is 0.98 V, contributing to a high cell efficiency of 63.7%. After 50 cycles (200 h operation), the round-trip overpotential increased slightly to 1.00 V, which corresponds to a cell efficiency of 62.3%. The cell voltage, power density, and cycle life maybe further improved by increasing the ionic conductivity and chemical stability of the solid electrolyte.

Although only exemplary embodiments of the invention are specifically described above, it will be appreciated that modifications and variations of these examples are possible without departing from the spirit and intended scope of the invention. For example, throughout the specification particular measurements are given. It would be understood by one of ordinary skill in the art that in many instances particularly outside of the examples other values similar to, but not exactly the same as the given measurements may be equivalent and may also be encompassed by the present invention.

1. A zinc (Zn)-air battery comprising:
a Zn metal anode;
an alkaline anode electrolyte disposed adjacent to the Zn metal anode;
a decoupled air cathode comprising an oxygen reduction reaction (ORR) component and an oxygen evolution reaction (OER) component, wherein the ORR component and OER component are physically separate;
an acidic catholyte disposed adjacent to the decoupled air cathode; and
a solid electrolyte disposed between the alkaline anode electrolyte and the acidic catholyte.

2. The Zn-air battery of claim 1, wherein the alkaline anode electrolyte comprises a compound comprising a hydronium (OH⁻) ion.

3. The Zn-air battery of claim 2, wherein the alkaline anode electrolyte comprises zincate (Zn(OH)₄²⁻).

4. The Zn-air battery of claim 1, wherein the neutral aqueous anode electrolyte comprises zinc ion (Zn²⁺).

5. The Zn-air battery of claim 1, wherein the nonaqueous anode electrolyte comprises zinc ion (Zn²⁺).

6. The Zn-air battery of claim 1, wherein the ORR component comprises an ORR catalyst.

7. The Zn-air battery of claim 5, wherein the ORR catalyst comprises a platinum/carbon (Pt/C) catalyst, palladium/carbon (Pd/C) catalyst, silver/carbon (Ag/C) catalyst or their alloys.

8. The Zn-air battery of claim 5, wherein the ORR catalyst comprises a cobalt-polypyrrole (Co-PPY-C) catalyst.

9. The Zn-air battery of claim 5, wherein the ORR catalyst comprises an iron/nitrogen/carbon(Fe/N/C) catalyst.

10. The Zn-air battery of claim 5, wherein the ORR catalyst comprises a carbon catalyst with hetero-atom dopants.

11. The Zn-air battery of claim 1, wherein the OER component comprises an OER catalyst.

12. The Zn-air battery of claim 9, wherein the OER catalyst comprises iridium oxide (IrO₂).

13. The Zn-air battery of claim 9, wherein the OER catalyst comprises a manganese oxide (MnOₓ).

14. The Zn-air battery of claim 9, wherein the OER catalyst comprises lead oxide (PbO₂).

15. The Zn-air battery of claim 1, wherein the ORR component, the OER component, or both comprises a gas diffusion layer.

16. The Zn-air battery of claim 1, wherein the ORR component, the OER component, or both comprises a conductive support.

17. The Zn-air battery of claim 1, wherein the catholyte comprises an acidic phosphate buffer.

18. The Zn-air battery of claim 15, wherein the acidic phosphate buffer comprises aqueous phosphoric acid (H₃PO₄).

19. The Zn-air battery of claim 15, wherein the catholyte comprises a phosphate dihydrogen ion (H₂PO₄⁻).

20. The Zn-air battery of claim 15, wherein the catholyte comprises an inorganic or organic acid.

21. The Zn-air battery of claim 18, wherein the inorganic or organic acid comprises HCl, H₂SO₄, HNO₃, HClO₄, CH₃COOH, C₃H₄O₄, or ant combinations thereof.

22. The Zn-air battery of claim 1, wherein the solid electrolyte comprises a material with higher lithium ion (Li⁺) diffusivity than hydrogen ion (H⁺) diffusivity.

23. The Zn-air battery of claim 1, wherein the solid electrolyte comprises Li_{1+x+y}Ti₂₋ₓAlₓP_{3-y}Si_{y}O₁₂ (LTAP).

24. The Zn-air battery of claim 1, wherein the solid electrolyte comprises a Li-ion, Na-ion, or K-ion conductor.

25. The Zn-air battery of claim 1, garnet (Li₇₋ₓLa₃Zr₂₋ₓTaₓO₁₂), perovskite (Li₃ₓLa_{(2/3)-x}□_{(1/3)-2x}TiO₃), LISICON (Li₁₄ZnGe₄O₁₆), silicon wafer, beta-Alumina, (Na_{0.75}Fe_{0.75}Ti_{0.25}O₂, K_{0.72}In_{0.72}Sn_{0.28}O₂), K₄Nb₆O₁₇, solid polymer electrolytes, and any combinations thereof.

26. The Zn-air battery of claim 1, wherein the battery has a discharge voltage of at least 1.5 V.

27. The Zn-air battery of claim 1, wherein the battery has a voltaic efficiency of at least 70% at 0.1 mA/cm².
